(19) United States
(12) Patent Application Publication
(10) Pub. No.: US 2003/0046173 A1
(43) Pub. Date: Mar. 6, 2003

(54) Store delivery of products ordered over a computer network

(76) Inventors: James A. Benjier, Plymouth, MN (US); Chapman K. Achen, St. Louis Park, MN (US)

Correspondence Address: Beck & Tysver, P.L.L.C., Suite 100, 2900 Thomas Avenue, Minneapolis, MN, 55416-4477, US

(21) Appl. No.: 09/943,468

(22) Filed: Aug. 30, 2001

(51) Int. Cl. G06F 17/60

(52) U.S. Cl. 705/26

(57) ABSTRACT

A method and system are presented for using the stock of one physical store, selected from among many physical stores, for the purpose of making a delivery of a product purchased through a virtual store. The appropriate physical store is selected based upon proximity to the customer and availability of the desired product as indicated by the computerized inventory maintained by the store. Once the store is selected and the customer selects local delivery, the order is sent to the store and a delivery request is sent to a local delivery service that services the store.

Upon receipt of the order, delivery tags are printed at the store. An employee of the store pulls the desired products from the store's inventory and tags the products for delivery. The results of the employee's efforts are input into to the system of the present invention. If the products are successfully retrieved, then shipping details are received from the shipping service and communicated to the customer. The shipping service then picks up the products and completes the delivery.

If the employee is unsuccessful in retrieving the products, this result is used to alter the stores computerized inventory, and, if possible, another store is selected. If no other local stores has the item in stock, the shipment is handled through the normal fulfillment processes of the virtual store.

### TECHNICAL FIELD

The present invention relates generally to electronic commerce over computer networks. More particularly, the present invention relates to the integration of a network of brick and mortar stores being used as a shipping source for products ordered over a computer network.

### BACKGROUND OF THE INVENTION

Many traditional retail companies have developed web sites on the World Wide Web to allow customers to shop over the Internet. Rather than seeing the web as a threat to their more traditional “brick & mortar” locations, these retail companies have viewed their web sites as a partner to their physical stores. With proper marketing and planning, the physical and virtual stores can benefit each other and build business through both channels.

One of the problems that is encountered by retailers that have adopted this “click & mortar” strategy is inventory management. Inventory must be maintained at the traditional stores and the warehouses that service them. At the same time, shipping locations and fulfillment partners must have access to inventory in order to ship to customers who order through the web site. Many retailers maintain two conceptual inventory systems, one for web site fulfillment and the other for the brick and mortar retail stores.

Another problem facing the click & mortar strategy of retailers is the minimization of shipping costs. Large retailers have spent a great deal of energy and resources streamlining the shipment and handling of products to geographical diverse retail stores. These efficiencies are often lost, however, when a customer orders a product over the Internet. Typically, Internet purchases are handled and shipped from a limited number of fulfillment locations that handle purchases from the web site. Thus, a purchaser of a television located in Tampa may be shipped the television from a fulfillment location in Memphis. This is true even though that same television may already be sitting in stock in a physical store located much closer to or even in Tampa.

What is needed is a way for click & mortar retailers to take advantage of the inventory found in physical retail locations for the fulfillment of purchases made over the Internet.

### SUMMARY OF THE INVENTION

The present invention meets this need by providing a system and method that utilizes individual store inventory for the purpose of fulfilling orders made over the Internet. In the preferred embodiment, the present invention is integrated into a system that also allows for a customer to pick-up an item ordered over the Internet at a physical store location.

The method for accomplishing this goal is to allow the customer to select local store delivery at the time that an order is placed via the web site. This option is presented to the customer only after two conditions have been met. First, at least one store must be identified as being located physically close to the customer. The actual distance between a physical store and a customer can vary from implementation to implementation. Second, inventories of the local stores must be electronically checked to verify that the item or items being ordered by the customer are found in the inventory of at least one of the local stores.

Once the system has verified that the ordered item is found in the inventory of a local store, the purchaser is presented with the option of having the item locally delivered. Other delivery options may be presented, including delivery from the standard web-site fulfillment location, or in-store pick-up at one of the discovered local stores.

If local delivery is selected, personnel at the local store having the item in inventory are contacted. At approximately the same time, the system places an order with a local delivery service to pick up the item and deliver it directly to the customer's address. The contacted employee is then responsible for physically taking the item from the store's available inventory and placing the item aside for local delivery. The employee then communicates to the system that the item has been successfully located and set aside for local delivery. After this, the present invention confirms that the local delivery service will be able to deliver the product. Once the shipping details have been verified with the shipping service, the time of delivery and tracking number are communicated to the customer, such as via e-mail, and the product is delivered.

### BRIEF DESCRIPTION OF THE DRAWINGS

FIG. 1 is a box diagram showing information and product shipping flow between the major parties of the present invention.

FIG. 2 is a flow chart showing the first portion of present invention method relating to the selection of local delivery.

FIG. 3 is a flow chart showing the second portion of present invention method relating to the holding of a product at a physical store location.

FIG. 4 is a flow chart showing the third portion of present invention method relating to the delivery of the product from the physical store location.

### DETAILED DESCRIPTION OF THE INVENTION

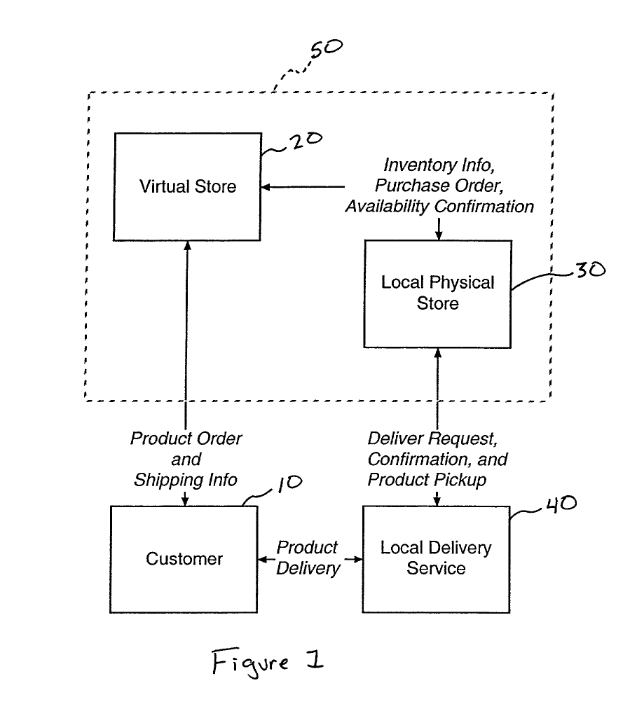

The present invention allows products purchased on-line to be delivered directly to the customer from a nearby, physical retail store. The key players in the present invention are shown in the block diagram of FIG. 1. This figure also shows information flow over a computer network or networks that is desired for the present invention. Each of the parties ideally will have a computerized system available for their use. These systems are then connected through a data network represented by the arrows connecting the blocks of FIG. 1.

As seen in FIG. 1, a customer 10 interacts with a virtual store 20, just as would happen in prior art e-commerce web sites on the World Wide Web. When the customer 10 has ordered a product through the virtual store 20, the virtual store 20 will check with the local physical store 30 to determine whether the product selected by the customer 10 is in stock at the local physical store 30. This is typically accomplished by checking the computerized inventory management system maintained by local store 30.

If the product is in stock, the virtual store 20 presents the customer 10 with the option of local delivery. If the customer 10 selects this option, a product order including a message to pull the product from stock is sent from the virtual store 20 to the physical store 30. An employee of the local physical store 30 then physically removes the product from stock. A local delivery service 40 is contacted to pick up the item from the local store 30 and deliver the product to the customer 10. Because the delivery is being accomplished locally, the customer can generally receive faster and less expensive delivery than if the virtual store simply delivered the product through a central fulfillment facility. In addition, the present invention is able to better leverage the existing inventory of products found in local physical stores 30.

The virtual store 20 and local store 30 will generally be part of the same retailer or be part of a partnership between separate retailers. This common ownership or partnership is shown in FIG. 1 as dotted box 50. The present invention will generally refer to a retailer 50 as the combination of the virtual store 20 and the physical store 30, even though there is no requirement in the present invention that a single entity own both parties 20,30. The communication between the virtual store 20 and the customer 10 and between the local physical store 30 and the delivery service 40 can be exactly as shown in FIG. 1. Alternatively, the virtual store 20 and the physical store 30 can communicate with external parties 10 and 40 as a unified entity, with the virtual store 20, the physical store 30, or another computer system handling all communication for the retailer 50.

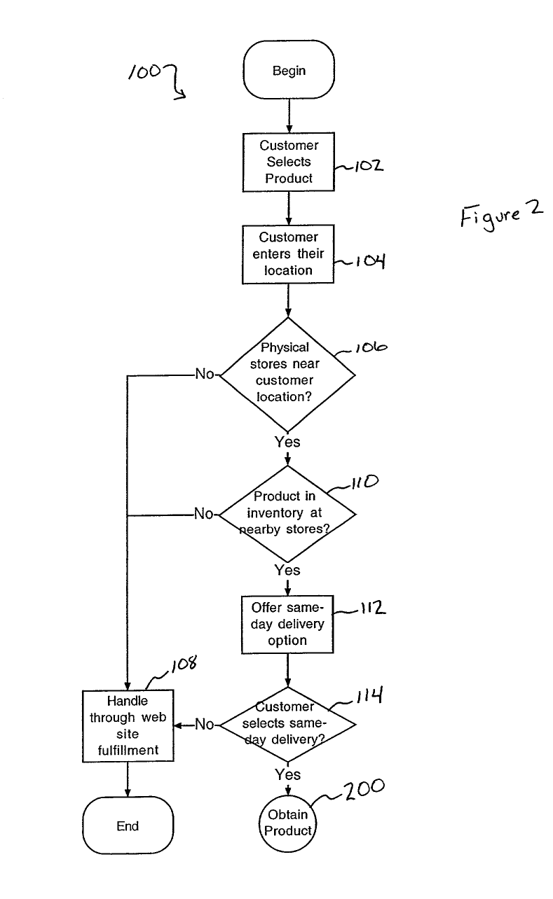

The method 100 of the present invention is shown in more detail in FIGS. 2 through 4. This method begins by allowing the customer 10 to select a product in the virtual store 20, which is shown as step 102 in FIG. 2. At the present time, the virtual store 20 will most likely be a web site on the World Wide Web, accessed by a web browser over the Internet. However, since the present invention does not rely on the protocols of the Web or the Internet, it would be well within the invention's scope to use another method for selecting a product through a virtual store 20. Other methods might include a web clipping service, the i-mode technology of NTT DoCoMo, or some other protocol now developed or developed in the future.

At any time while shopping, the virtual store 20 can determine the physical brick & mortar stores 30 that are located close to the customer 10. These stores 30 can be used as pick-up locations if the customer 10 so chooses, or the stores 30 can be used as the shipping point for local shipping under the present invention. In the preferred embodiment, more than one store 30 can be designated as local for each customer 10. To determine the local stores 30, the virtual store 20 requests that the customer 10 enters their local address, as shown in step 104. The virtual store 20 then locates physical stores 30 near the customer 10. If the virtual store 10 does not find any local stores 30, as determined by step 106, the option of local delivery would not be available for that customer 10. Rather, the virtual store 20 would handle delivery through fulfillment locations normally used by the virtual store 20 (step 108), and the process 100 would be completed.

Once local physical stores 30 are found to exist for a customer 10 in step 106, the virtual store 20 will check the computerized inventory for these stores 30. If none of the product selected by the customer 10 is in stock at any of the local stores 30, then step 110 will direct the virtual store 20 to handle delivery through its normal fulfillment channels (step 108). If the product is in stock at one or more of the local stores 30, the virtual store 20 will offer the customer 10 the option for local delivery at step 112. The offer of local delivery can be made in parallel with an offer for local pick-up of the product at one of the local stores 30. These two offers can be made separately among a list of available delivery options, such as: 1) ground delivery, 2) two-day delivery, 3) next-day delivery, 4) local store pick-up, or 5) same-day local delivery direct from your local store. Alternatively, local store pick-up and local delivery can be presented as a single option at this point, with the selection between these options not occurring until after the local store 30 has verified the availability of the product by pulling it from inventory.

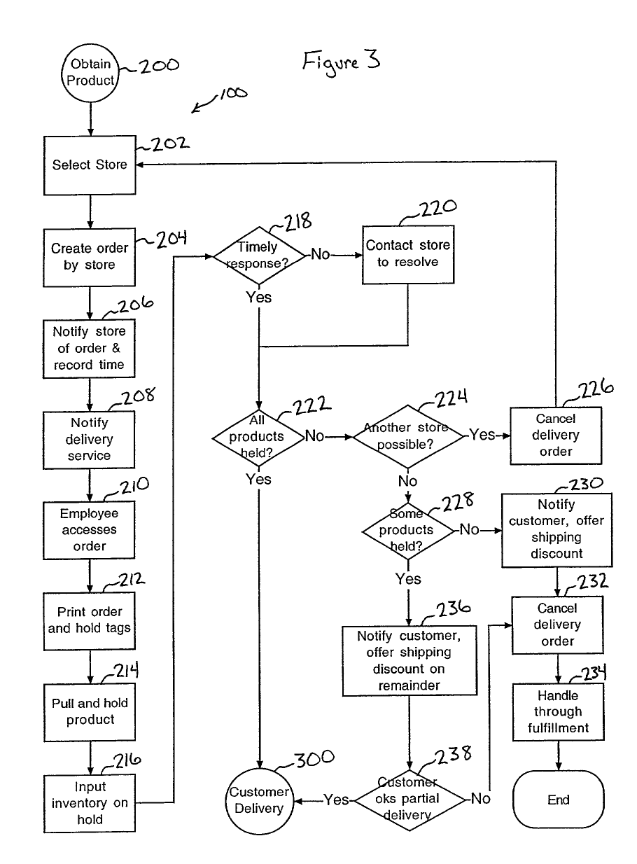

If the customer does not select local delivery in step 114, the virtual store 20 will deliver the product through normal fulfillment processes 108. If local delivery is selected at step 114, the method 100 continues at the “Obtain Product” section 200 of method 100, which is shown in FIG. 3.

The first step 202 in obtaining the product 200 is for the virtual store 20 to select one of the local stores 30 that has the product in inventory. If only one local store was found to have the product in inventory in step 110, this step is trivial. If multiple stores have the product, than the process 100 will attempt to select a store using some pre-established business rules. For instance, step 202 could select the store 30 physically closest to the customer 10, or select the store 30 with the largest inventory for the product, or even select the store 30 that the customer 10 has previously indicated to be a “preferred” location. Alternatively, step 202 could analyze prior local delivery orders to determine if the present order could be advantageously combined with an existing delivery order. If so, the store 30 having the existing delivery order will be selected for this delivery.

Once a local store 30 is selected, it is necessary to create an order for the store 30 in step 204. The order will contain the product or products being ordered and identifying information for the customer 10. The order will also preferably contain at least a portion of the credit card number used to place the order at the virtual store 20, which can be used to verify that the customer 10 receiving or picking up the product is the same person that ordered the product.

The order is then sent to the local store 30. Ideally, the sending of the order is also accompanied by some notification that an order has been sent, such as by sending a page to a pager that is used by the employees of the local store 30. The receipt of a page will indicate to the employee that an order has been received. Additionally, the virtual store 20 should track the time that the order and notification was sent to the local store 30. All of these elements relating to the sending of an order to the local store 30 take place in step 206 of FIG. 3.

Once the order has been sent to the local store 30, it is also wise to communicate to the local delivery service 40 that a product will be ready for delivery within the next few hours (step 208). Typically, this notification will be made to a third party not related to the retailer 50 or the customer 10. This third party could be a delivery management service that contracts with the retailer 50 to provide a certain level of service within a delivery area. The delivery management service could have its own fleet of delivery vehicles, or could subcontract with other delivery services. Alternatively, the delivery service could be owned and managed by the same retailer 50 that owns the virtual store 20, the physical store 30 or both. The management details of the delivery service 40 are outside the scope of the invention. Nonetheless, the service should be able to provide a reasonable guarantee of pick-up and delivery times, and should have the ability to track the status of a delivery.

When an employee of the local store 30 receives a notice that an order has been placed for local delivery, the employee accesses the order through a convenient interface at the local store 30 (step 210). This interface could be networked computer, a wireless handheld organizer, or a similar digital communication device. The interface should allow the employee to print out the order and, ideally, print out delivery tags that can be placed directly upon the ordered product (step 212).

With the printed order and delivery tags in hand, the employee then pulls the products from stock and attaches the delivery tags in step 214. The products are generally placed in a hold location within the physical store 30 along with other items being set aside for local delivery. The employee will then use their interface device to input the fact that the products have been placed in the hold area in step 216. This step 216 will also update the computerized inventory for the products in store 30.

It is possible that the employee of the local store 30 will not be able to place all of the products ordered by the customer 10 on hold. This may occur because of a discrepancy between the computerized inventory checked in step 110 and the actual in-store inventory. Alternatively, it is possible that the products desired by the customer were sold between the time of the check in step 110 and the time the employee went to pull the items in step 214. If a product is not found in stock, step 216 will update the computerized inventory to indicate that no products are currently in stock.

The virtual store 20 will time the duration between the notification of step 204 and the confirmation of step 216. If step 218 determines that this duration has exceeded a desired time, such as one hour, it is necessary to contact the store 30 to determine the cause for the delay. This contact is accomplished in step 220. Although steps 218 and 220 are shown in FIG. 3 as happening in series with steps 208-216, steps 218 and 220 ideally occur in parallel, and will be triggered whenever the delay between steps 206 and 216 exceeds the desired time.

Step 222 determines whether less than all of the ordered products were pulled in step 214. If so, the present invention then checks to see if any other local store 30 can fulfill this deliver order more completely (step 224). This is accomplished by determining if any other local store 30 has the ordered items in stock according to their computerized inventories. If another store 30 is found to have the products available, then it is necessary to cancel the delivery order placed with the local delivery service 40 in step 226, and then repeat the process of obtaining the products with a newly selected store at step 202.

If no other stores 30 are found to have the ordered products in stock, step 228 will determine if the order can be partially filled (i.e., whether any of the products in the order were placed on hold in step 214). If not, the customer 10 is notified of the situation in step 230. Typically, this notification will include some discount on normal shipping, or even an offer of free shipping to make up for the inconvenience. In step 232, the delivery service 40 is notified that this delivery order has been cancelled. The order for the product is then handled through normal web site fulfillment channels in step 234, and the process for local delivery 100 ends.

If some items have been held, as determined by step 228, the customer 10 is notified of the situation in step 236 and is offered the option to split the order between local delivery 40 and some other delivery mechanism. If the customer 10 does not wish the order to be split, as determined by step 238, the delivery order is cancelled in step 232 and the entire order is handled through the web site fulfillment mechanism in step 234.

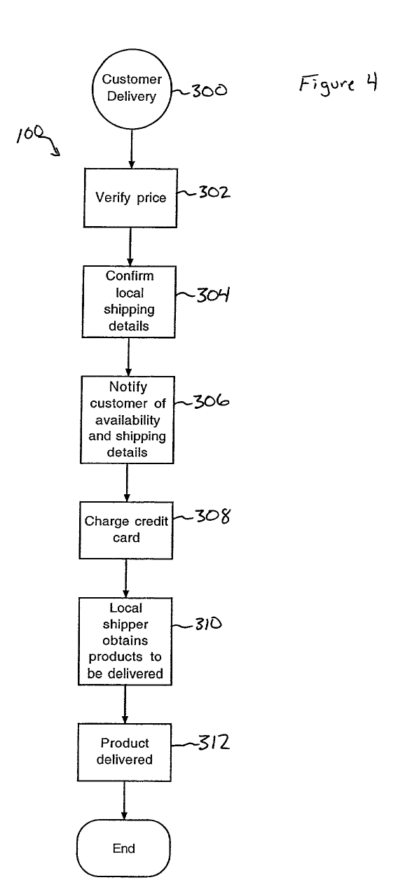

If the customer 10 is willing to split the order in step 238, or if step 222 determines that all of the products in an order have been found, then the customer delivery portion 300 of the method 100 is executed, as shown in FIG. 4. The first step 302 of this process is to determine the appropriate price for the products in this order. It is possible that the price for identical products can vary between the local store 30 and the virtual store 20. In the preferred embodiment, step 302 will compare the virtual store price with the local store price, and give the customer 10 the benefit of the lowest price.

Next, it is necessary to figure the details of the local shipping arrangement in step 304. This step 304 requires communication with the delivery service 40 contacted in step 208. Because of the time that passes between 208 and step 304, it is expected that the deliver service 40 will be able to verify certain shipping details, such as the pick up time, the expected delivery time, and the tracking number that will used to identify this delivery. These details are gathered in this step 304, preferably by means of an electronic communication between a computer operated by the delivery service 40 and the computer(s) used by the retailer 50.

It is possible that a delivery service 40 will not be able to pick up the products within an acceptable time frame. Generally, this situation will be avoided by developing relationships with one or more delivery services 40 that will guarantee nearly 100 percent availability. However, if the delivery service 40 contacted in step 208 notifies the retailer 50 that timely delivery will not be made, the retailer 50 will either contact another delivery service 40, or will contact the customer 10 and handle the order through the normal fulfillment process of the virtual store 20. Ideally, the preferred embodiment will begin working on one of these contingencies as soon as notice of non-availability is received from shipping service 40.

Once the delivery details are confirmed in step 304, the customer 10 is notified that the products will be delivered (step 306). This step will also provide the customer 10 with the delivery details

Once it is clear that the product will be delivered to the customer 10, the retailer 50 will charge the customer's credit card for the products in the order (step 308). In step 310, the local shipper 40 picks up the products from the local store 30. Finally, in step 312, the shipper 40 delivers the products to the appropriate customer 10. Because this is a local delivery, the delivery will likely be made either on the same day as the order was placed with the virtual store 20, or, if the order was made late in the day, on the next morning. In addition, because this shipping is local, the shipping costs for the retailer 50 and the consumer 10 may well be reduced.

Of course, many possible combinations of features and elements are possible within the scope of the present invention. Therefore the scope of the present invention is to be limited only by the following claims.

What is claimed is:

1. A method of delivering a purchased product comprising:
a) presenting a plurality of products to a customer through a virtual store;
b) receiving a request to purchase a particular product from the customer;
c) receiving a delivery address for the customer;
d) selecting from a plurality of physical stores at least one local physical store located near the delivery address for the customer;
e) reviewing a computerized inventory for the local physical stores to determine if any of the local stores have the particular product in inventory;
f) if one of the local physical stores have the product in inventory, offering an option of local delivery to the customer;
g) if the customer selects the option of local delivery, pulling the particular product from the inventory of one of the local physical stores; and
h) delivering the pulled particular product to the delivery address of the customer.

2. The method of claim 1, wherein step g) further comprises:
i) sending over a computer network a local delivery product order to one of the local physical stores,
ii) notifying an employee of one of the local physical stores that a local delivery product order has been sent, and
iii) sending a notification to a local delivery service that a delivery is to be made from one of the local physical stores to the delivery address.

3. The method of claim 2, wherein step g) further comprises:
iv) printing a delivery tag based upon the product order,
iii) locating the particular product in the physical store,
iv) placing the delivery tag on the particular product, and
iii) relocating the particular product into an area of the physical store associated with local delivery.

4. The method of claim 3, wherein step g) further comprises:
iv) entering into an interface an indication as to whether the particular product was located in the physical store, and
v) if the indication shows that the particular product was not located in the store, canceling the local delivery and selecting a new physical store.

5. A method of delivering a purchased product in a retail environment having a virtual store and a plurality of physical stores that use a computerized inventory system to track inventory, the method comprising:
a) receiving a purchase request from a customer for the purchased product via the virtual store;
b) determining at least one local physical store located near the customer;
c) determining from among the local stores at least one eligible store having the purchased product in inventory according to the computerized inventory system;
d) identifying the purchased product and the customer to one of the eligible stores;
e) pulling the purchased product from the inventory of the eligible store; and
f) delivering the purchased product to the customer.

6. The method of claim 5, wherein step c) further comprises:
i) selecting physical stores having the purchased product in inventory according to the computerized inventory system, and
ii) choosing one eligible store from among the selected stores according to predetermined business rules.

7. The method of claim 6, wherein the predetermined business rules are chosen from among the following set: choosing the store closest to the customer, choosing the store having the largest inventory for the purchased product, choosing the store having a preexisting delivery order that could be combined with the delivery of the purchased product, choosing the store pre-selected by the customer.

8. The method of claim 5, wherein step d) further comprises:
i) composing a product order for the purchased product, the order having content that identifies the purchased product, the customer, and a delivery address for the customer, and
ii) transmitting the product order to one of the eligible stores via a computer network.

9. The method of claim 8, wherein step d) further comprises:
iii) notifying an employee of one of the eligible stores that the order has been transmitted.

10. The method of claim 9, wherein the step of notifying an employee is accomplished by paging the employee.

11. The method of claim 9, wherein step d) further comprises:
iv) tracking a first time at which the employee was notified,
v) tracking a second time at which the purchased product is pulled from inventory, and
vi) if the duration between the first and second times exceeds a preset threshold, using a second means of communicating with the one of the eligible stores to verify that the product order was received.

12. The method of claim 8, wherein the order content further includes a portion of a credit card number used by the customer in making the purchase request.

13. The method of claim 8, wherein step e) further comprises:
i) printing a tag for the product that is generated from the content of the product order, and
ii) placing the tag on the purchased product that is pulled from inventory.

14. The method of claim 13, wherein pulling the purchase product from inventory includes placing the pulled product in an area of the eligible store reserved for local deliveries.

15. The method of claim 5, wherein step e) further comprises:
i) printing a tag for the product that contains the name and address of the customer, and
ii) placing the tag on the purchased product that is pulled from inventory.

16. The method of claim 5, wherein step e) further comprises:
i) entering results of pulling the product from inventory into a digital interface, and
ii) communicating the results to the virtual store.

17. The method of claim 16, wherein step e) further comprises:
iii) if the results indicate that the product was not successfully pulled from inventory, returning to step c) and determining another eligible store.

18. The method of claim 17, wherein step e) further comprises:
iv) if sub-step iii) is unable to determine another eligible store, communicating to the customer that the delivery process failed and delivering the product through a virtual store fulfillment process separate from the inventory of the physical stores.

19. The method of claim 16, wherein step f) further comprises:
i) notifying a local delivery service via a computer network that the purchased product is available for pick up at the eligible store,
ii) obtaining delivery details from the local delivery service, and
iii) communicating the delivery details to the customer before the purchased product is delivered.

20. The method of claim 16, wherein the local delivery service is notified at approximately the same time that the purchased product and the customer are identified to the one of the eligible stores.

21. The method of claim 16, wherein the local delivery service is provided with a cancellation notice if the results of step e) indicate that the employee was unsuccessful in pulling the product from inventory.

22. The method of claim 5, wherein step f) further comprises:
i) notifying a local delivery service via a computer network that the purchased product is available for pick up at the eligible store,
ii) obtaining delivery details from the local delivery service, and
iii) communicating the delivery details to the customer before the purchased product is delivered.

23. A system for delivering a purchased product comprising:
a) a local delivery service computer system having
i) an interface to receive delivery orders over a network for local delivery of a product, and
ii) an ability to track delivery orders during the local delivery process;
b) a physical store computer system for managing aspects of at least one of a plurality of physical stores, the physical store computer system having
i) an inventory management portion to maintain a separate real-time inventory for each physical store, and
ii) an interface to allow an employee to review an order for the product and to input a result for pulling the product from inventory;
c) a virtual store computer system having
i) an e-commerce portion to offer the product for sale to customers,
ii) a physical store selection portion to determine an eligible physical store from the plurality of physical stores based upon the location of the physical stores and whether the physical store has the product selected by the customer in-stock, and
iii) a physical store interface to communicate the order for the product to the physical store computer system for the eligible physical store; and
d) a delivery request system to communicate the delivery order to the local delivery service computer system after the customer selects a local delivery option for the product.
